(19) United States
(12) Patent Application Publication
(10) Pub. No.: US 2004/0136456 A1
(43) Pub. Date: Jul. 15, 2004

(54) Encoding digital video for transmission over standard data cabling

(76) Inventor: James Ogden, Chudleigh (GB)

Correspondence Address: Ira S Dorman, Suite 200, 330 Roberts Street, East Hartford, CT, 06108, US

(21) Appl. No.: 10/476,780

(22) PCT Filed: May 9, 2002
(86) PCT No.: PCT/GB02/02173

(51) Int. Cl. H04N 7/12

(52) U.S. Cl. 375/240.01

(57) ABSTRACT

LVDS data from a DVI source is decoded into parallel word format and passes through a colour space reduction stage before being stored in a frame buffer. Compressed pixel data may be read from the frame buffer or alternatively the frames may be read at a reduced refresh rate. Colour space reduction, compression and lowering of the refresh rate are all implemented dynamically to maintain the quality of the video information within a reduced bandwidth.

### TECHNICAL FIELD OF THE INVENTION

This invention relates to techniques for transmitting digital video for substantial distances over relatively low bandwidth data cabling.

### BACKGROUND

It is often necessary to send video signals from a personal computers (PC) over a distance of tens of metres to be displayed on a remote monitor. A Digital Video Interface (DVI) standard has been defined for sending high speed digital video data using low voltage differential signals (LVDS) over short lengths of custom cable up to a few metres, and such DVIs are now widely used in PCs. The maximum bit rate which a single LVDS channel can carry is roughly 1.6 Gb/s (gigabits per second), and the maximum compound bit rate of a single DVI link containing separate red, green and blue channels is therefore 1.6×3 Gb/s=4.8 Gb/s. The physical DVI interconnection medium has capacity for two links plus a synchronous clock, allowing a maximum of 9.6 Gb/s data transfer. Implementation of the second link is reserved for future high resolution video modes.

Category 5 data cable (often abbreviated to CAT5) is commonly used to carry data signals over distances of tens of metres. Such cable contains four pairs of wires which are capable of carrying four separate data signals. Practical experience shows that bandwidths of about 100 MHz (corresponding to 0.1 Gb/s) are possible using simple differential driving and receiving circuits. Analogue signals can be transmitted over such bandwidths, proving that sufficient amplitude levels can be achieved. However, if data is sent over such cabling in a purely digital format it will be apparent that a single cable is only capable of a maximum data rate of 4×100 MHz=400 Mb/s. Thus, the data rate of DVI signals is roughly twelve times too high for such data cabling. It is possible to increase the data transfer capability of the category 5 cable using modulation techniques, which is used in the 1000BaseT physical link layer to attain 1 Gb/s over four twisted pairs.

Data compression techniques are commonly used to reduce bandwidth. One option would be to install a custom video card and driver which is capable of performing compression algorithms using the DSP architecture available on modem PCs. However, this solution would take up additional limited resources in the PC. The objective of this invention is to provide a new and inventive solution which utilises existing DVI facilities and cabling infrastructure.

### SUMMARY OF THE INVENTION

The present invention proposes a method of sending DVI signals along a cable of limited bandwidth, in which the data rate of the incoming video signals is monitored and the signals are processed to dynamically reduce their information content as the data rate of the incoming signals increases so as to restrict the bandwidth of the output signals for transmission along the cable.

The invention further provides apparatus for sending DVI signals along a cable of limited bandwidth, which includes:

monitoring means for monitoring the data rate of the incoming video signals; and

processing means responsive to the monitoring means to process the signals such that their information content is dynamically reduced as the data rate of the incoming signals increases so as to restrict the bandwidth of the output signals for transmission along the cable.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a schematic block diagram of a video driver which employs bandwidth reduction in accordance with the invention; and

FIG. 2 is a schematic block diagram of a video receiver for decoding the signals from the driver.

### DETAILED DESCRIPTION OF THE DRAWINGS

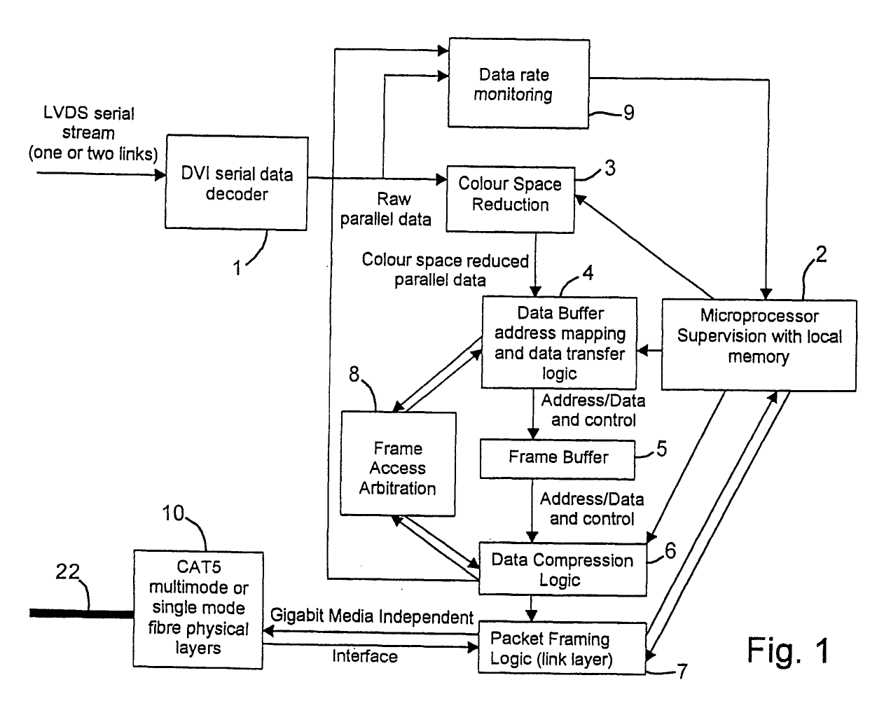

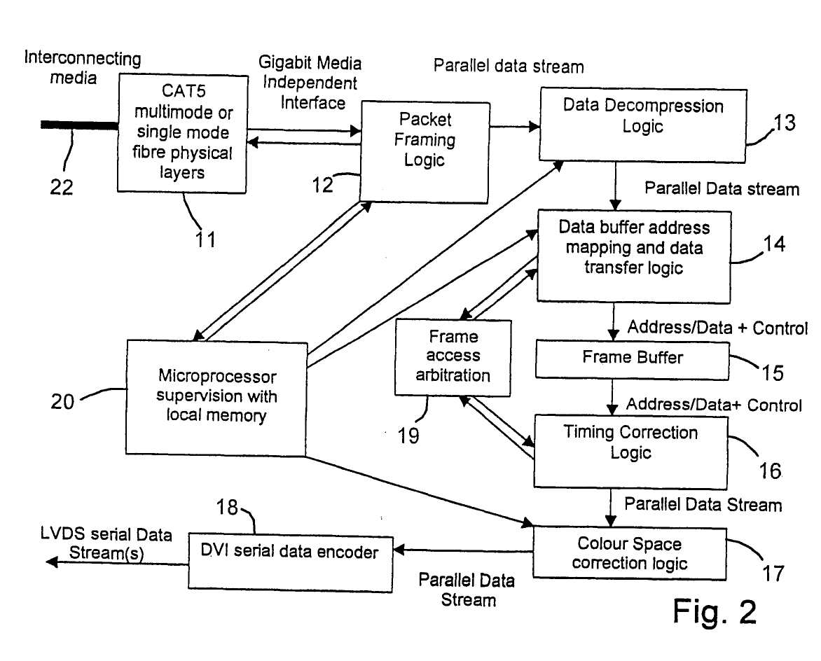

The driver shown in FIG. 1 is intended to receive an LVDS serial data stream (one or two links) from a DVI source in a PC and, after signal processing, transmit the resulting video information over a CAT5 cabling infrastructure 22. At the receiving end the incoming data is decoded using the receiver shown in FIG. 2 to be displayed on a flat screen LCD monitor.

Referring to FIG. 1, data enters the driver in Digital Visual Interface (Panel Link) LVDS serial data format with a maximum data rate of around 1.6 Gb/s per channel, there being 6 channels contained within a single DVI cable. The incoming data is decoded into its raw data format using an off-the-shelf LVDS serial data decoder chipset 1. The decoded data is in a raw parallel word format. This data is of considerably lower frequency than the incoming LVDS data, allowing simpler manipulation in the digital domain. The parallel data rate is evaluated at this point by means of a data rate monitoring circuit 9.

Overall control and management of the driver is supervised by microprocessor 2 with its own local RAM, which receives input from the data rate monitoring circuit 9. The microprocessor will make modifications to the signal processing path as described below to accomplish the required data reduction.

The parallel data enters a first data reduction stage 3 in which the colour space may be converted into a reduced bit per pixel format. For example, the colour space mapping of each red, green and blue pixel may be reduced from 256 discrete levels (8 bits×3=24 bits) to 16 (4 bits×3=12 bits). The amount of colour space reduction is dynamically manipulated under the control of the microprocessor 2 using external control registers to vary the degree and nature of the colour compression.

The processed parallel data is then fed via address mapping and data transfer control logic 4, supervised by microprocessor 2, into a frame buffering stage 5 capable of storing at least two frames. The mapping logic 4 generates address and control information which is sent to the frame buffer 5 to control the writing of pixel data to the buffer. The buffered information need not necessarily be updated on a successive frame-by-frame basis. This buffer stage also acts as a difference detection engine, evaluating and comparing the stored frame data. During the write operation, a comparison between the data buffers takes place (concurrent task) and a data bit is set in the buffer indicating whether the data is original or updated (new) information.

Data is removed from the frame buffer 5 under supervision of microprocessor 2 by means of a data compression logic stage 6 which received the address and control information from the frame buffer along with the read data. This stage is capable of delivering data at a reduced rate compared with that of the frame input, so that frame reduction takes place (reduced refresh rate). This data is removed from the frame buffer which is not currently being written to, the buffer being locked for writing until the whole frame has been read. The read and write circuits 6 and 4 access the frame buffer contentiously, arbitrated by a frame access arbitration circuit 8. In another mode of operation which can be set by the microprocessor 2, instead of reading the complete frame only the new data is transferred along with relative addressing information. This mode is implemented dynamically depending on whether it creates an acceptable compression ratio as determined by the data rate of the resulting output signals which is dynamically assessed by the monitoring circuit 9. By monitoring the data rate of the raw input data and of the output data following the compression stages it is possible to monitor the effectiveness of the various compression algorithms and dynamically modify them to continuously respond to the nature of the input video signals. Such dynamic link evaluation allows vision quality to be decreased (by lowering colour resolution and/or implementing data compression algorithms) to improve frame update speeds when appropriate, and vice versa. In general, high data rates caused by rapidly moving images will implement reduction of colour resolution and, if necessary, implementation of data compression whilst maintaining optimum refresh rates. On the other hand, the best response to high data rates due to high image resolution (a large amount of fine detail) will be to reduce refresh rates followed, if necessary, by implementation of colour reduction and data compression.

Additional layers of compression may be applied at the data compression stage 6. For example, lossy compression algorithms can be employed.

The compressed data is then packetized by packet framing logic 7 (link layer) for transfer across a standard Gigabit Media Independent Interface 10. The packet framing logic is designed for optimal one-way data transfer with a facility to receive lower bandwidth data in the opposite direction. The data management of the link is controlled by the microprocessor 2.

The Digital video information may then be driven down a physical multimode or single mode cable or fibre medium 22. It should be noted that this does not have to be CAT5. More than one GMII could be available, allowing the data to be shared across several independent cable mediums.

The driver thus employs several means of reducing the overall bandwidth of the final output. The control of the data reduction methods is handled by the supervisor micro-processor 2 which receives information about the data stream and may also control other ancillary services such as remote keyboard and mouse for example. The microprocessor may also handles the transfer of control data over the cable link in either direction.

Referring to FIG. 2, at the remote end of the cable link 22 the receiver handles the conversion back into a format compatible with the monitor's DVI interface. The incoming compressed and packetized data is received by a gigabit Ethernet physical layer chipset(s) 11. The GMII output from the chipset facilitates a media independent layer between the Physical and Link components of the Gigabit Ethernet specification. Packet framing logic 12 decodes the data from the GMII interface into a parallel data stream which is readily manipulated by the following stages.

A receive microprocessor 20 with local RAM communicates with the driver microprocessor 2 which can be arranged to configure the link for different types of cable media, also communicating data formatting and flow information. The receive microprocessor 20 controls the decoding of packet data and also supervises the data decompression stages as described below.

Primary data decompression logic 13 handles any de-compression required before the colour space correction phase controlled by the microprocessor 20. This may include such schemes as frame difference, in which persistent data patterns do not generate any new data. If the frame difference feature is implemented it is also under the control of the processor 2 which evaluates whether the function would improve the quality of service.

Data buffer address mapping logic 14 supervised by microprocessor 20 paginates and stores the incoming parallel data in a frame buffer 15 which is capable of buffering at least two frames. The control logic 14 sends address and control signals to the frame buffer 15 to manage the write process. If the frame difference engine is enabled at the driver, data is only updated at the specified addresses. The data is written into the frame buffer that is not being read by the timing correction logic. Once the data buffer address mapping logic has rendered a full frame of up-to-date data, the frame buffer is swapped in synchronisation with the clocking of timing correction stage 15, causing remote video data to be updated. Frame buffer access is controlled by frame access arbitration circuit 19.

The timing correction logic 16 reads the data from the frame buffer 15 using address and control commands to bring the frame and line refresh rate back to a standard acceptable by the monitor attached to the system. This produces an increase in bandwidth.

A colour space correction stage 17 re-maps the colours if a reduction in bits per pixel has taken place in the driver. This ensures that colour space distortions are kept to a minimum. This again causes an increase in bandwidth.

An LVDS encoder 18 takes the data in parallel format and generates the serial LVDS signals required to interface to standard DVI connectors at the monitor input.

Thus, by allowing flexibility in hardware for the data reduction, an optimal dynamic solution may be obtained. Take for example a full motion picture being displayed at 1600×1200 resolution. The quantity of new data may well exceed the bandwidth of the frame difference coding. In order to compensate for this, a reduction in colour space may occur, allowing a respectable refresh rate to be achieved without causing agitation to the user. On the other hand, if essentially static screen information is being displayed at very high resolutions, it may be preferable to optimise the colour information and reduce the refresh rate when the screen display changes.

Although by way of example the above description relates to a link employing a single CAT5 cable it should be noted that more than one cable may be used. Indeed, this may become commonplace when dual link DVI is implemented.

It will be appreciated that the features disclosed herein may be present in any feasible combination. Whilst the above description lays emphasis on those areas which, in combination, are believed to be new, protection is claimed for any inventive combination of the features disclosed herein.

1. A method of sending DVI signals along a cable of limited bandwidth, in which the data rate of the incoming video signals is monitored and the signals are processed to dynamically reduce their information content as the data rate of the incoming signals increases so as to restrict the bandwidth of the output signals for transmission along the cable.

2. A method according to claim 1, in which the video signals are processed to dynamically reduce their colour resolution as the data rate of the incoming signals increases.

3. A method according to claim 2, in which, after being sent along the cable, the colour resolution of the video signals is dynamically increased in accordance with the amount of reduction which took place prior to transmission along the cable.

4. A method according to claim 1, in which the video information is stored in a frame buffer.

5. A method according to claim 4, in which, at high data rates, the stored video information is read from the frame buffer at a reduced refresh rate to reduce the information content of the output signals.

6. A method according to claim 5, in which, after being sent along the cable, the output signal is stored in a frame buffer and the stored information is read from the buffer at an increased data rate.

7. A method according to claim 1, in which, as the data rate of the incoming signals increases, a compression technique is applied to the stored video information to reduce the information content of the output signals.

8. A method according to claim 7, in which, after being sent along the cable, the video signals are decompressed.

9. A method according to claim 1, in which the video information is stored in a frame buffer, as the data rate of the incoming signals increases a compression technique is applied to the stored video information to reduce the information content of the output signals, and the compression technique includes comparing the pixel information contained in the stored frames to determine which pixels have changed and transmitting the changed pixel data together with pixel address information.

10. A method according to claim 1, in which the incoming DVI signals are converted to a parallel data format for processing.

11. Apparatus for sending DVI signals along a cable of limited bandwidth, which includes:
monitoring means for monitoring the data rate of the incoming video signals; and
processing means responsive to the monitoring means to process the signals such that their information content is dynamically reduced as the data rate of the incoming signals increases so as to restrict the bandwidth of the output signals for transmission along the cable.

12. Apparatus according to claim 11, in which the processing means processes the video signals to dynamically reduce their colour resolution as the data rate of the incoming signals increases.

13. Apparatus according to claim 12, which includes, at the receiving end of the cable, means for dynamically increasing the colour resolution of the video signals in accordance with the amount of reduction which took place prior to transmission along the cable.

14. Apparatus according to claim 11, in which the video information is stored in a frame buffer.

15. Apparatus according to claim 14, which includes means operable at high data rates to read the stored video information from the frame buffer at a reduced refresh rate to reduce the information content of the output signals.

16. Apparatus according to claim 15, which includes, at the receiving end of the cable, a frame buffer for storing the output signal and means for reading the stored information from the frame buffer at an increased data rate.

17. Apparatus according to claim 11, which includes compression means for applying a compression technique to the stored video information as the data rate of the incoming signals increases, to reduce the information content of the output signals.

18. Apparatus according to claim 17, which includes, at the receiving end of the cable, means for decompressing the video signals.

19. Apparatus according to claim 11, which includes a frame buffer for storing the video information, compression means for applying a compression technique to the stored video information as the data rate of the incoming signals increases, to reduce the information content of the output signals, and means for comparing the pixel information contained in the stored frames to determine which pixels have changed, and means for transmitting the changed pixel data together with pixel address information.

20. Apparatus according to claim 11, which includes means for converting the incoming DVI signals to a parallel data format for processing.
